(19) United States
(12) Patent Application Publication
(10) Pub. No.: US 2013/0132522 A1
(43) Pub. Date: May 23, 2013

(54) Transportation vehicle's remote data storage system

(71) Applicant: Arthur Oded Ruppin, Ringwood, NJ (US)

(72) Inventor: Arthur Oded Ruppin, Ringwood, NJ (US)

(21) Appl. No.: 13/303,706

(22) Filed: Nov. 23, 2011

(51) Int. Cl. G06F 15/16

(52) U.S. Cl. 709/219

(57) ABSTRACT

A transportation vehicle (TV) remote data storage system increases the survivability, the ability to retrieve and to create a more comprehensive and larger TV's data set than that is saved by a TV's black box by having the real time assembled data saved in a safe and secure site. The TV data storage system of the present invention is a remote data storage system to be used onboard aircraft, automobiles, trains, water transportation vehicles, etc., which has usages in three modes: (i) Mode 1, as a remote back up black box to a TV's installed black box; (ii) Mode 2, as an offsite black box when an in-TV black box is not installed; and (iii) Mode 3, as an offsite black box when more data is required to be saved off site than what is saved in the TV's black box.

### BACKGROUND OF THE INVENTION

1. Field of the Invention

This invention relates to transportation vehicle (hereinafter “TV”) data storage systems, and more specifically to remote data storage systems that receive and store the data transmitted wirelessly from the transportation vehicle in real time. The TV data storage systems described in this application apply to all kinds of TVs including but not limited to aircraft, automobiles, trains, water transportation vehicles, etc.

2. Description of Related Art

The transportation vehicle (hereinafter “TV”) data storage system used on the aircraft is commonly known as a ‘black box’, which may include a flight data recorder (FDR) and a cockpit voice recorder (CVR). Typically, the FDR onboard the aircraft records specific performance parameters, operating conditions of the flight, such as time, altitude, airspeed, heading, and aircraft attitude. Typically, the CVR records conversation in the cockpit, radio communications with ground air traffic control, ambient sounds such as engine noise, landing gear extension and retraction, etc. Although modern technologies have been utilized in aviation including auto pilots on aircraft, the aircraft operator(s) still play critical roles in controlling the complex aircraft system. Piloting an aircraft demands proficiency of numerous skills, good physical and mental conditions. However, aviation with long hours and shift-work could cause increasing fatigue due to circadian rhythm disturbances and cockpit pressure changes. As people become more fatigued they become more forgetful, inattentive, making poor decisions and their responses become slowed and variable. Thus, real-time health/fatigue/awareness monitoring is crucial to early detection before the pilot's vital signs and cognitive performance is affected. Therefore, a number of real time health/fatigue/awareness monitoring devices (AMD) have been proposed to early recognize potential hazards.

When the TV data storage system is installed onboard TVs other than aircraft (e.g. automobiles, trains, water transportation vehicles, etc.), it is commonly known as an event data recorder (EDR) because it is used to record information related to vehicle crashes or accidents. These EDR may include video camera which records the activities in front of the TV in a loop of several hours. A high percentage of TV accidents occurred due to lacking of awareness because drivers are tired, drowsy or fatigue. Therefore, in addition to EDR, both automakers and independent electronics companies have been developing awareness monitoring devices (AMD), to monitor driver's awareness, such as, lane-departure warnings, an eye-movement monitor, etc.

However, there are multiple disadvantages of the black box installed on aircraft. Whenever an aircraft crashes, it may be necessary for the investigators to search a large area in order to retrieve the black box. Even though the black box is intended to be tempered proof, it may be damaged with the aircraft crash and would need to be reconstructed. However, at times the damage might be too much for the black box to be reconstructed. Moreover, due to limited space on the aircraft, the CVR records on a continuous loop of tape that commonly recycles itself every 30 minutes and the EDR commonly runs on a 25-hour loop. The EDR will be disposed or erased if it is not analyzed. Also, most of the AMD share the drawbacks of limited storing capacity. There is no system to archive recorded EDR, CVR, or AMD for future analysis and long term monitoring. The EDR and AMD on other transportation vehicles (e.g. automobiles, trains, water transportation vehicles, etc.) are similar to the black box onboard aircraft, thus, sharing these similar disadvantages and are not archived for long term monitoring or future analysis.

There have been a number of patents providing solutions to the problems related to FDR, CVR, or EDR. More specifically, by way of example, U.S. Pat. No. 5,890,079 to Levine (1999) discloses automatic, real-time collection of aircraft data and then transmission of such data to a worldwide communication system for subsequent reception, analysis, storage and generation of aircraft flight, safety, fuel efficiency and maintenance advisories at a Central Ground Based Processing Station (CGBS).

U.S. Pat. No. 6,092,008 to Bateman (2000) U.S. Pat. No. 6,092,008 to Bateman (2000) discloses a flight event record system and method which records in-flight information at ground based installations during the flight of an aircraft and which permits ground based personnel to monitor in real time or at a later time the flight of the aircraft.

U.S. Pat. No. 7,039,509 to Podowski discloses a method for preserving information from an airborne aircraft includes: receiving an activation signal; establishing a call from the aircraft to a ground support facility over a wireless telecommunications network in response to the activation signal.

U.S. Pat. No. 7,436,322 to Crank (2008) discloses an invention primarily records audio, video and data in separate channels onboard an aircraft or vehicle, and then transmits, upon demand or prerequisite circumstances to a ground-based facility where it is analyzed. This reduces demand upon satellite transmission, while reducing the number of personnel and data storage space needed to monitor aircraft.

U.S. Pat. Nos. 6,108,523; 6,308,045 to Wright et al. discloses a wireless ground data link, through which flight performance data provided by airborne data acquisition equipment is stored, compressed, encrypted and downloaded to an airport-resident ground subsystem, which forwards flight performance data files from various aircraft to a flight operations control center for periodical analysis.

The concept of flight/event data being sent to a black box on the TV and, at the same time, the data is sent to a backup recorder at a secure location such as a recorder at a ground location are described in some of the above mentioned patents.

However, none of them at the same time stores in the securely located back up data storage the additional information that is not recorded by the black box on the TV. These additional information that are typically not recorded by the traditional black box onboard the TV can be additional flight/event data related to TV's performance, health/fatigue/awareness of the TV's operators and/or conversations that occurred in the passenger cabin between the TV crew and passengers or between passengers and passengers, etc.

Recording activities that are occurring in the passenger cabin may help to spot the disruptive, violent, passengers, or passengers who are carrying a knife, a gun, etc. before any mishap happens. The passenger cabin voice or video record should be treated in the same manner as CVR recordings. The CVR recordings are treated differently than the other factual information (such as EDR data) obtained in an accident investigation. Due to the highly sensitive nature of the verbal communications inside the cockpit, a high degree of security is provided for the CVR audio and its transcript. The content and timing of release of the written transcript are strictly regulated: under federal law.

Furthermore, since airline recorded information regulations keeps on changing to accommodate more and more important parameters and other in-flight characteristics to aid in the investigation or monitoring of aircraft, more and more storage space would be needed and ways to organize the information gathered. It is necessary to have data storage unit(s) that allows for more data space to back up the important parameters saved in the aircraft's black box and to store other in-flight characteristics that are not stored on the traditional aircraft's black box, such as aforementioned aircraft's operators' health/fatigue/awareness (AMD) data, passenger cabin activities data, etc., which can aid in the investigation. These increasing regulating demands may also apply to other types of TVs. In order to fulfill their intended purpose, current flight/event data recorders (black box) must be made crash resistant. Consequently, they are constructed of rugged materials which means that they are costly to produce and heavy. It may be cost effective to have a large central data storage unit that all TVs can use than having black box installed on each TV.

Therefore, although all the aforementioned patents may satisfy their own intended purposes, there still exists a need for a remote TV data storage system that can save data wirelessly and directly from collecting devices onboard a TV that doesn't have a black box installed onboard. There also exists a need for a remote TV data storage system that can back up the black box onboard the TV, and save additional data that's not saved by a traditional black box onboard the TV, and thus creating/storing a more comprehensive record of a TV's data, which may be used for real-time monitoring and/or future analysis.

The background technology necessary to carry out the present invention is readily available; however, this inventive concept has not been suggested.

### SUMMARY OF THE INVENTION

The TV's remote data storage system described in this application apply to all kinds of TVs including but not limited to aircraft, automobiles, trains, water transportation vehicles, etc.

One object of the present invention is to provide a TV's remote data storage system that can simplify the complexity and uncertainty involved in investigating all kinds of TVs' accidents.

Another object of the present invention is to provide a TV's remote data storage system to backup in real time the data in a traditional black box onboard a TV.

Another object of the present invention is to provide a TV's remote data storage system that can store in real time the health/fatigue/awareness of the TV's operators through awareness monitoring device(s) (the AMD).

Yet another object of the present invention is to provide a TV's remote data storage system that can store in real time the additional information, which a traditional black box onboard a TV normally will not record in order to capture a more complete set of TV data.

A TV's remote data storage system according to the present invention can simplify the TVs' accidents investigation and ensure that the flight/event data plus additional information are completely retrieved. The remote data storage system of the present invention can provide more comprehensive flight/event data record, including additional information that the traditional black box normally will not record, to help investigate the TVs' accidents or any other mishaps without the need to go through enormous troubles to retrieve black boxes onboard the TVs. Since the information is recorded and being sent wirelessly for offsite storage, it can be sent to a ground monitoring station for real-time monitoring.

The TV's remote data storage systems according to the present invention have usages in three modes:

(i) Mode 1, as a remote back up data storage system to a TV's installed black box, this back-up system may be onboard a TV or may be off-site;

(ii) Mode 2, as an off-site data storage system when an onboard TV black box is not installed;

(iii) Mode 3, as an off-site data storage system when more information are required to be stored and monitored off-site than what are saved in the TV's black box.

Prior to TV data storage, the TV data need to be collected by the data collection device(s) of various technologies that are installed onboard the TV or attached to the TV operator(s) at the location of which the performance, activities and/or vital signs is to be monitored. The collected data are then sent from the collection device(s) through communication channels to the TV interface.

The remote TV data storage system of the present invention for mode 1 and 3 may include: (1) a Global Navigation Satellite System (G.N.S.S. receiver/transmitter) (to determine the position of the TV; (2) a black box body installed on the TV to receive and store the collected data via TV interface; (3) at least one transmitter that transmits in real time, wirelessly, the data to the outside of the TV; (4) means for data communication including but not limited to global communication system and/or cellular and/or telemetry, or any combination of thereof; (5) at least one remote reception device receiving the information data transmitted from the transmitter(s) in real time through means for data communication; and (6) at least one remote data storage device to save the data.

The TV's onboard black box may include the following components: power supply, crash survivable memory unit (CSMU), integrated controller and circuitry board (ICB), and/or underwater locater beacon (ULB) (for water transportation vehicle and aircraft). The ICB contains the electronic circuitry that acts as a switchboard for the incoming data.

Global Navigation Satellite System (G.N.S.S.) determines the position of the TV and transmits these information to the G.N.S.S. receiver onboard the TV that sends the information through a communication channel to the TV interface.

The data collection devices are installed on a TV at the location of which performance is to be monitored. After the data collection devices collect the data, the data is sent to the TV interface through communication channels. The TV interface is the port that serves as the connection for the input from the data collection devices and stores the information it receives and passes it through communication channels into a data compression/decompression system, a TV identification (ID) system, and into the TV installed “black box”.

In addition, the data is sent through a transmitter through a global communication satellite system, cellular communication, telemetry and/or any combination thereof to the receiver on the remote data storage system (can be onboard the TV or located on the ground) for back up storage.

AMD data may be stored in the onboard black box. However the best mode is to store it in the off-site data storage system due to the limited space of the onboard black box.

In an embodiment of mode 3, additional data such as less critical operational or performance flight data, the TVs' operator's health/fatigue/awareness monitoring data, and the video or audio record of interactions between TV crews and passengers and/or passengers and passengers that are collected anywhere onboard the TVs may be transmitted and stored in the off-site remote data storage system.

The remote TV data storage system of the present invention for mode 2 may include the same components except that the black box body is not installed onboard the TV(s). For the mode 2 that doesn't have a TV onboard black box, TV interface serve as connection port between a data collecting device and a compression/decompression system; the data collected by the data collecting device are sent to a compression/decompression system to be processed and sent to the transmitter that transmits the data wirelessly to the off-site storage system on the ground equipped with a receiver.

In the first mode, the transmitter most likely shall be physically but can also be wirelessly connected to the black box onboard the TV. In the second, the transmitter shall receive the data directly from independent source(s) onboard the TV (e.g. data collective devices including all sorts of detectors/sensors, audio recording devices, video cameras, etc.). In the third mode, it may receive data from both the black box and independent source(s) onboard the TV

The TV's remote data storage system of the present invention for mode 1, 2, and 3 may further comprise (1) at least one data collection devices installed on an aircraft to collect data at the location of which performance, activities, and/or vital signs are to be monitored; and (2) communication channels for data collection devices to send data to the TV's interface.

A method according to the present invention comprises the following steps: transmitting the collected data in real-time related to TVs, which may include TVs' performance parameters and operational conditions (flight/event data), CVR data, global positioning data, altitude data, AMD data, and audio video data of interactions between crews and passengers with TVs' identification through means for communication; receiving such data by a receiver; and stored such data in a TV's data storage system.

The information recorded includes various flight/event data, such as engine status, fuel status, speed, position, altitude, control settings, and cockpit acoustic information as well as TV operator(s)' health/fatigue/awareness monitoring data (AMD data). The information comes from sensors in the cockpit and at other strategic locations around the TVs such as passenger cabin/seating to record flight images and conversation between TV crews and disruptive, violent, passengers, or passengers who are carrying a knife, a gun, etc., a conversation that is never recorded by the traditional block box in a TV.

There are three advantages of said remote system that can be summed up as follows:

1. It is possible to create a very large data base situated on various parameters and thereby have the ability to affect the overall TVs performance. There are many implications for this and one important feature would be in regard to fuel consumption and its usage under various conditions. There can exist conditions that effect fuel consumption such as wind direction and speed. By collecting data repeatedly from a specific TV or from a group of TVs flying along the same route one would be allowed the ability to analyze such data and instruct a TV to fly accordingly to save fuel consumption. This is something that may not be possible to achieve with an onboard stand alone system itself. It is important to note that stationary based computers can run more powerful programs, faster and more effectively than the ones found on a TV itself.

2. It is possible to collect data and analyze it when an operating crew has changed TVs and track such as information about said operating crew. For example, a pilot's performance can be tracked even though said pilot may be operating a different TV on a different route at various times.

3. The ability to analyze different types of TVs. For example, said system can be used to determine which TV is more fuel efficient while flying under certain conditions. If a TV is carrying 300 passengers on a 200 mile route system could determine that different TVs might get different results on a 200 mile route than on a 700 mile route).

The method may further comprise the steps of collecting the aforementioned data via data collecting devices including sensors and detectors of various technologies; and communicating such data to the TV interface for further process.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting. A recitation of “a”, “an” or “the” may mean “one or more” and should not be regarded as limiting to only “one”.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a flow chart illustrating mode 1 of the TV data storage system according to the present invention;

FIG. 2 is a flow chart illustrating mode 2 of the TV data storage system according to the present invention; and

FIG. 3 is a flow chart illustrating mode 3 of the TV data storage system according to the present invention.

### DESCRIPTION OF THE PREFERRED EMBODIMENT

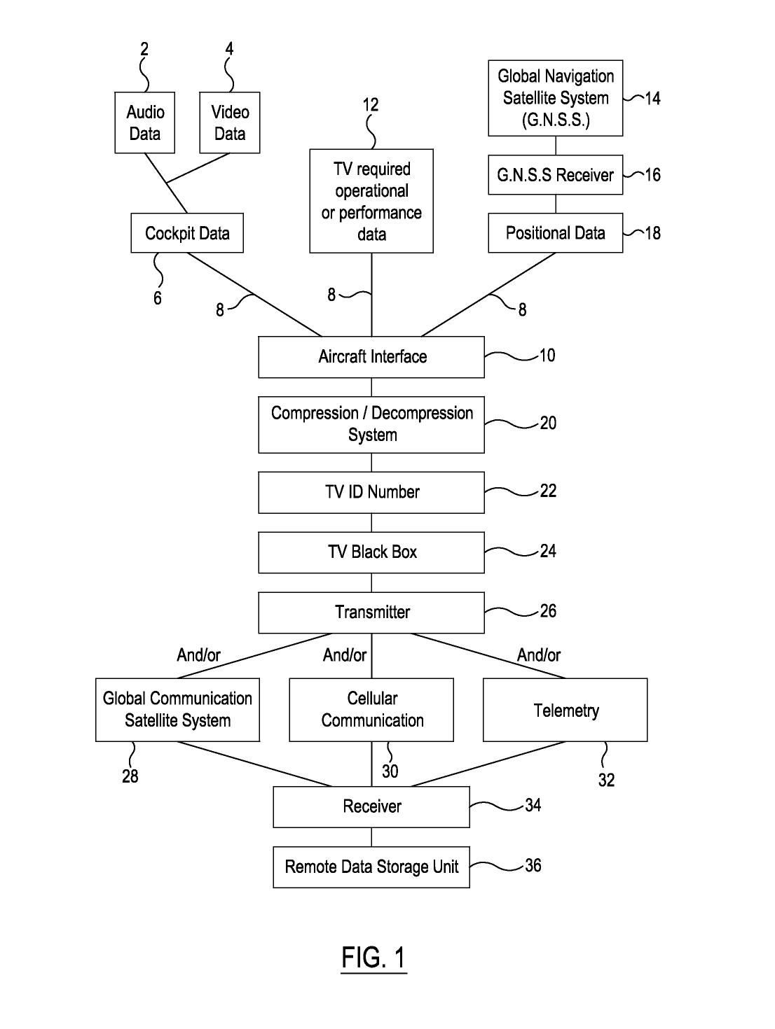

Referring to FIG. 1, there is disclosed a block diagram (flow chart) of the mode #1 of TV data storage system 100, which functions as a remote back up data storage to a TV's installed black box. Audio Data 2 on the TV is collected by microphones placed strategically onboard the TV. Video data 4 on TV is collected by internal and external cameras placed strategically onboard the TV. Audio data 2 that are collected in the cockpit (cockpit data 6) include but are not limited to TV operators' conversation, radio communications, and ambient sound. These cockpit data 2, and video data 4 are sent through a communication channel 8 to an aircraft interface 10. TV performance and operational data 12 such as engines status, fuel status, speed, and control settings are also collected and sent through a communication channel 8 to TV's interface 10. Global Navigation Satellite System (G.N.S.S.) 14 determines the position of the TV and transmits the positional data 18 to the G.N.S.S. Receiver 16 onboard the TV, and then sends to TV's interface 10 through a communication channel 8. Data 4, 6, 12, 18 is then sent from the aircraft interface 10 to a compression/decompression system 20, and then such data is stored with an aircraft identification number 22 in the TV black box 24. At the same time, the same data with aircraft ID number 22 is sent from a transmitter 26 through a communication system (e.g. global communication satellite system 28, cellular communication 30, telemetery 32, and/or any combination thereof) to the receiver 34 on TV remote data storage unit 36. In this mode, the transmitter most likely shall be physically but can also be wirelessly connected to the black box.

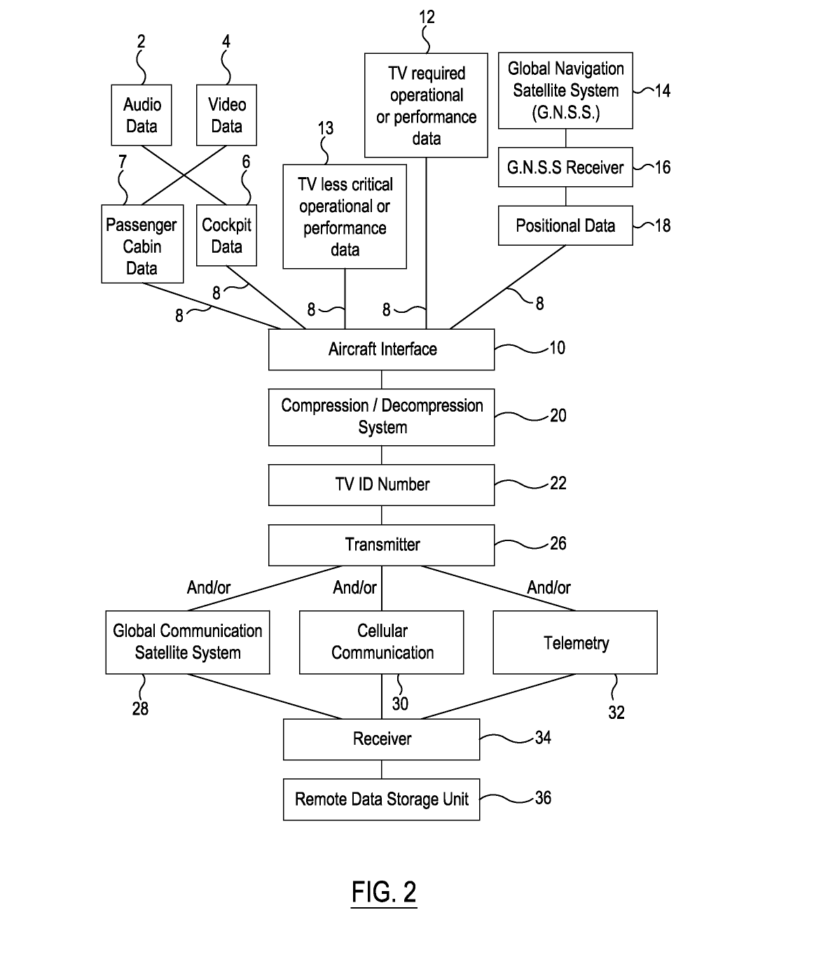

FIG. 2 illustrates a flow chart for an embodiment of mode #2 of the TV data storage system 100 according to the present invention. Mode #2 embodiment does not have black box installed on the TV. Audio Data 2 on the TV is collected by microphones placed strategically onboard the TV Video data 4 on TV is collected by internal and external cameras placed strategically onboard the TV. TV performance and operational data 12 are also collected via sensor(s)/detectors based on various technologies. Audio data 2 that are collected in the cockpit (cockpit data 6) include but are not limited to TV operators' conversation, radio communications, and ambient sound. Additional information such as AMD data 3 that monitors the TV operators' health/fatigue/awareness is collected via sensors attached to and/or worn by TV operators. Other information such as conversations occurring in the passenger cabin between the crew and disruptive, violent, passengers (Passenger cabin data 7) can also be collected. These cockpit data 6 and video data 4 as well as TV's critical performance and operational data 12 such as engines status, fuel status, peed, and control settings are sent through a communication channel 8 to TV's interface 10. Other TV's less critical operational or performance data 13 are also collected and sent through a communication channel 8 to an aircraft interface 10. Global Navigation Satellite System (G.N.S.S.) 14 determines the position of the TV and transmits the positional data 18 to the G.N.S.S. Receiver 16 onboard the TV, and then sends to an aircraft interface 10 through a communication channel 8. Data 3, 4, 6, 7, 12, 13, 18 is then sent from the aircraft interface 10 to a compression/decompression system 20 and such data with aircraft ID number 22 is sent from a transmitter 26 through a communication system (e.g. global communication satellite system 28, cellular communication 30, telemetery 32, and/or any combination thereof) to the receiver 34 on TV remote site data storage unit 36. In this mode, the transmitter 26 receives the data directly from the sources.

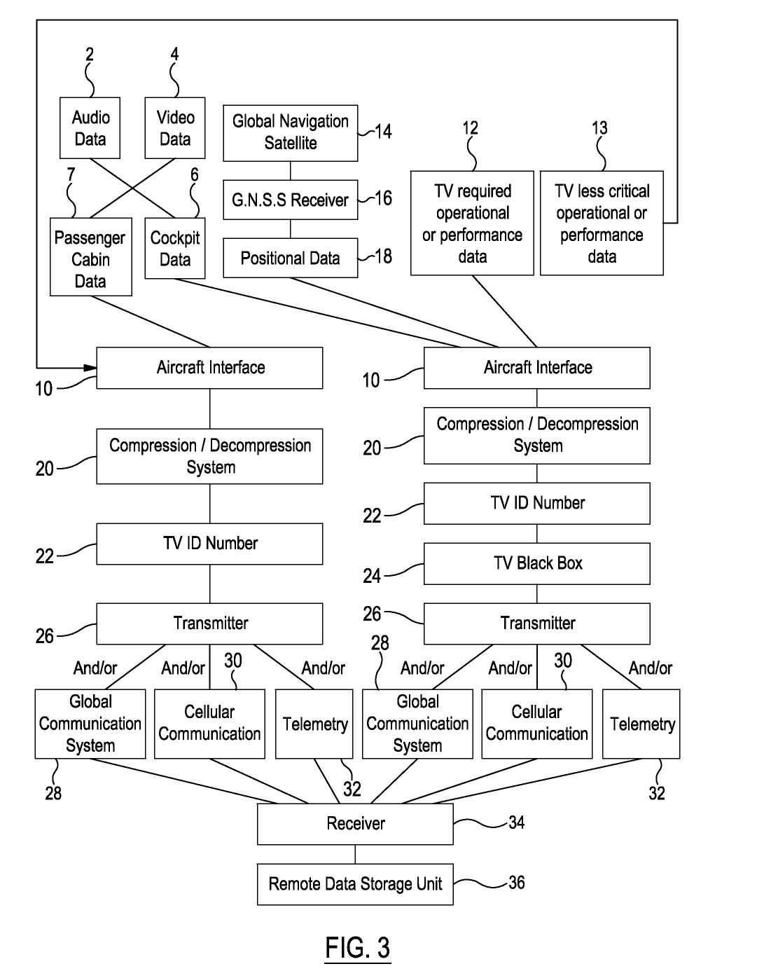

Referring to FIG. 3, there is disclosed a flow chart for an embodiment of mode #3 of the TV data storage system 1 of the present invention. The TV data storage system 1 in mode #3 works as an offsite black box when more data is required to be saved off site than what is saved in the TV's black box. Audio Data 2 on the TV is collected by microphones placed strategically in/on the TV. Video data 4 on TV is collected by internal and external cameras placed strategically in the TV. TV performance and operational data 12 are also collected via sensor(s)/detectors based on various technologies. Audio data 2 that are collected in the cockpit (cockpit data 6) include but are not limited to TV operators' conversation, radio communications, and acoustic sound. Additional information that are normally not recorded by the traditional black box in the TV, such as AMD data 3 that monitors the TV operators' health/fatigue/awareness can be collected via sensors attached to and/or worn by TV operators. Other information such as conversations occurring in the passenger cabin between the flight attendants and disruptive, violent, passengers that are not recorded by the traditional black box in the TV (Passenger cabin data 7) can also be collected. The critical audio data 2 including cockpit data 6 and video data 4, as well as TV's critical performance and operational data 12 such as engines status, fuel status, airspeed, and control settings are sent through a communication channel 8 to an aircraft interface 10. AMD data 3 and Other TV's less critical operational or performance data 13 are also collected and sent through a communication channel 8 to an aircraft interface 10. Global Navigation Satellite System (G.N.S.S.) 14 determines the position of the TV and transmits the positional data 18 to the G.N.S.S. Receiver 16 onboard the TV, and then sends to an aircraft interface 10 through a communication channel 8. Data 3, 4, 6, 7, 12, 13, 18 is then sent from the aircraft interface 10 to a compression/decompression system 20. The important data 4, 6, 12, 18 are stored with an aircraft identification number 22 in the TV black box 24. At the same time, the same data 2, 4, 6, 12, 18 with TV's identification 22 is sent from a transmitter 26 through a communication system (e.g. global communication satellite system 28, cellular communication 30, and telemetry 32, and/or any combination thereof) to the receiver 34 on TV remote site data storage unit 36. The additional data (passenger cabin data 7, AMD data 3, and TV less critical operational or performance data 13) are not stored in the onboard TV black box 24 but are instead transmitted by the transmitter 26 through a communication system 28, 30, 32, and stored in the remote site data storage unit 36 with the corresponding receiver 34. In mode #3, the remote site TV data storage unit on the ground may receive data from the onboard TV black box and/or from independent source(s) or sensor(s)/detector(s).

Which type of audio data 2 or video data 4 is critical to be saved in onboard black box may vary depending on the onboard black box data storage size.

The TV's remote site data storage system allows data from different TVs (such as from aircraft 1 and aircraft 2) to be stored in the same storage system and allows easy/quick extraction of particular TVs' data. The data collected is digitized so it can be sent by any communication means known in the art to any locations including TV monitoring stations. Because data is being transmitted in real time over high speed communications, TV monitoring station can have a system setup that de-scrambles continuous data streams they receive to separate audio data from video data, etc so these data can be examined and compared to normal data parameters. If actual data falls outside the normal data parameters, then an alert/alarm system may be triggered.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A transportation vehicle (TV) data system comprises: (1) at least one transmitter that wirelessly transmits data in real time; (2) means for data communication including but not limited to global communication system, cellular phone, telemetry, and/or any combination thereof; (3) at least one remote reception device receiving the data transmitted by the transmitter(s) in real time; (4) at least one remote data storage device; and (5) a Global Navigation Satellite System (G.N.S.S. receiver/transmitter) to determine the position of the TV.

2. The TV data system of claim 1 further comprises a black box installed onboard the transportation vehicle.

3. The TV data system of claim 1 further comprises a plurality of data collection devices installed onboard the TV to collect data at the location of which performance and activities is to be monitored; and communication channels for data collection devices to send data to the TV interface; wherein the data collection devices may be various types of sensors, detectors, audio recorder, and/or video camera.

4. The TV data system of claim 3, wherein the data collection devices may be sensors attached to and/or worn by TV operator(s) to monitor the health/fatigue/awareness of the TV operator(s).

5. The TV data system of claim 2, wherein the black box installed onboard the TV comprises: a power supply; a crash survivable memory unit (CSMU); and an integrated controller and circuitry board (ICB).

6. The TV data system of claim 5 further comprises an underwater locater beacon (ULB).

7. The TV data system of claim 2, wherein the remote data storage device back up the data stored in the black box onboard the TV in real time.

8. The TV data system of claim 1, wherein the remote data storage device stores the data collected by collecting devices onboard the TV in real time.

9. The TV data system of claim 2, wherein the remote data storage device back up the data that is typically saved in a black box onboard the TV in real time plus additional data that is not saved in the black box onboard the TV in real time.

10. The TV data system of claim 9, wherein the data typically saved in a black box onboard a TV in real time may be TV's critical operation and performance data, and/or TV operator(s)' conversation, radio communication.

11. The TV data system of claim 9, wherein the additional data includes but is not limited to the TV operator(s)' health/fatigue/awareness monitoring data.

12. The TV data system of claim 9, wherein the additional data includes but is not limited to the audio and/or video data recorded anywhere in all kinds of TVs of interactions between the crew and the passengers and/or the interactions between the passenger and passenger.

13. A method according to the present invention comprises the following steps: (a) transmitting, in real-time, TV's performance parameters, operational conditions, TV's global positioning data, altitude data, and TV's identification via data communication means to a receptor connected to a remote data storage system; and (b) storing the data received in the remote data storage system.

14. The method of claim 13 further comprises the following steps: (a) transmitting, in real-time, TV operator(s) health/fatigue/awareness monitoring data, TV operator(s) conversations, radio communication via data communication means to a receptor connected to a remote data storage unit; and (b) storing the data received in the remote data storage system.

15. The method of claim 14 further comprises steps of (a) collecting in real-time the TV's performance parameters, operational conditions, TV's global positioning data, altitude data, TV operator(s) awareness monitoring data, TV operator(s) conversations, radio communication via data collection devices; and (b) communicating such data to TV interface.

16. The method of claim 13, wherein the remote data storage system backs up the data stored in the black box onboard the TV in real time.

17. The method of claim 14, wherein the remote data storage system back up data that is stored in the black box onboard the TV in real time plus additional data that is not saved in the black box on the TV.

18. The method of claim 14, wherein the transmitters sends the data to the remote data storage system without an onboard black box involved.

19. The TV data system of claim 2, wherein the transmitter may be physically or wirelessly connected to the TV onboard black box.

20. A TV data system according to the present invention have usages in three modes:
(i) a remote back up data storage system to back up data saved in a TV's installed black box, this back-up system may be onboard a TV or may be off-site;
(ii) an off-site data storage system for saving TV's data when an onboard TV black box is not installed; and
(iii) an off-site data storage system when more information are required to be stored and monitored off-site than what are saved in the TV's black box.
